(19) United States
(12) Patent Application Publication
(10) Pub. No.: US 2007/0125627 A1
(43) Pub. Date: Jun. 7, 2007

(54) APPARATUS AND METHOD FOR CHARACTER INPUT

(75) Inventors: Chin-Feng Chen, Shenzhen, Guangdong (CN); Tay-Yang Lin, Shenzhen, Guangdong (CN); Te-Yao Yeh, Shenzhen, Guangdong (CN); Xiao-Guang Li, Shenzhen, Guangdong (CN); Kuan-Hong Hsieh, Shenzhen, Guangdong (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/563,030

(22) Filed: Nov. 24, 2006

(30) Foreign Application Priority Data
Dec. 1, 2005 (CN) 200510102121.8

(51) Int. Cl. H01H 13/72

(52) U.S. Cl. 200/5 A

(57) ABSTRACT

An apparatus for character input is disclosed. The apparatus includes a keypad and a processing unit. The keypad comprises a plurality of combo keys. Each combo key includes a main contact and at least one sub-contact adjacent to the main contact, the main contact and the sub-contact respectively have at least one icon representing a character. The processing unit receives a press operation on the keypad and inputting a corresponding character. The keypad of the apparatus is compact in size while character input on the keypad is conveniently.

### BACKGROUND OF THE INVENTION

1. Field of the Invention

The present invention relates to an apparatus and a method for character input.

2. Description of Related Art

Hand-held devices with text input capabilities have become more and more popular. These devices, for example, mobile phones and personal digit assistants, usually adopt a keypad for character input function. The keypad typically has fewer keys than a QWERTY keyboard. Several characters are arranged on a single key of the keypad. For example, a single key represents a number and two or three characters at the same time. Inputting characters on the keypad is time consuming. A user usually needs to operate keys a plurality of times to input one character.

Therefore, what is needed is an apparatus for rapid character input using a new kind of keypad.

### SUMMARY OF THE INVENTION

An apparatus for character input is disclosed. The apparatus includes a keypad and a processing unit. The keypad comprises a plurality of combo keys. Each combo key includes a main contact and at least one sub-contact adjacent to the main contact. The main contact and the sub-contact respectively have at least one icon representing a character. The processing unit receives a press operation on the keypad and inputting a corresponding character.

A method for character input which is used in an electronic device is disclosed. The method comprising the steps of: a) Providing a key board. The keypad includes a plurality of combo keys. Each combo key includes a main contact and at least one sub-contact adjacent to the main contact. The main contact and the sub-contact respectively have at least one icon representing a character. b) Depressing a combo key. c) Inputting a corresponding character.

Further features and advantages will be provided or will become apparent in the course of the following detailed description.

### BRIEF DESCRIPTION OF THE DRAWINGS

FIG. 1 is a schematic, front view of an electronic device with a keypad according to a first preferred embodiment of the present invention;

FIG. 2 is a schematic diagram of a hardware infrastructure of the electronic device of FIG. 1;

FIG. 3 is a schematic, front view of the keypad of FIG. 1;

FIG. 4 is a schematic, isometric view of a combo key of FIG. 3;

FIG. 5 is a cross section view of FIG. 4;

FIG. 6 is a flowchart of a preferred method of character input used in the electronic device of FIG. 1; and

FIG. 7 is a schematic, front view of a keypad according to a second preferred embodiment of the present invention.

### DETAILED DESCRIPTION OF THE INVENTION

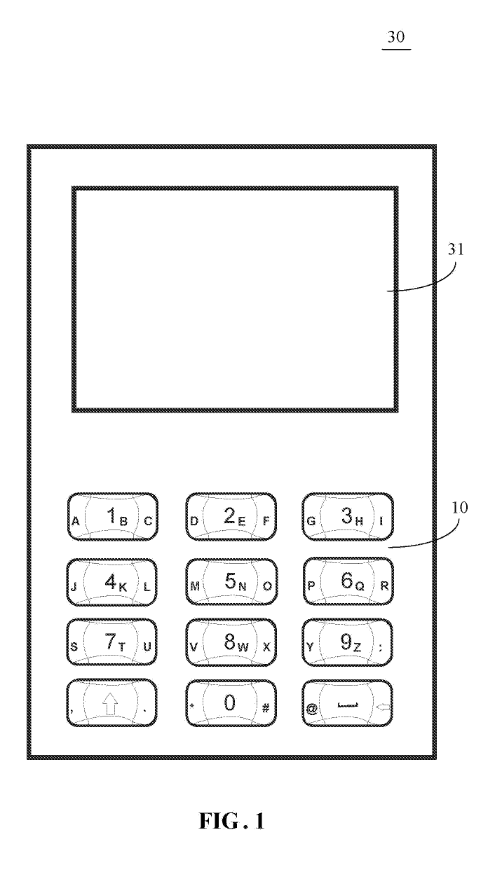

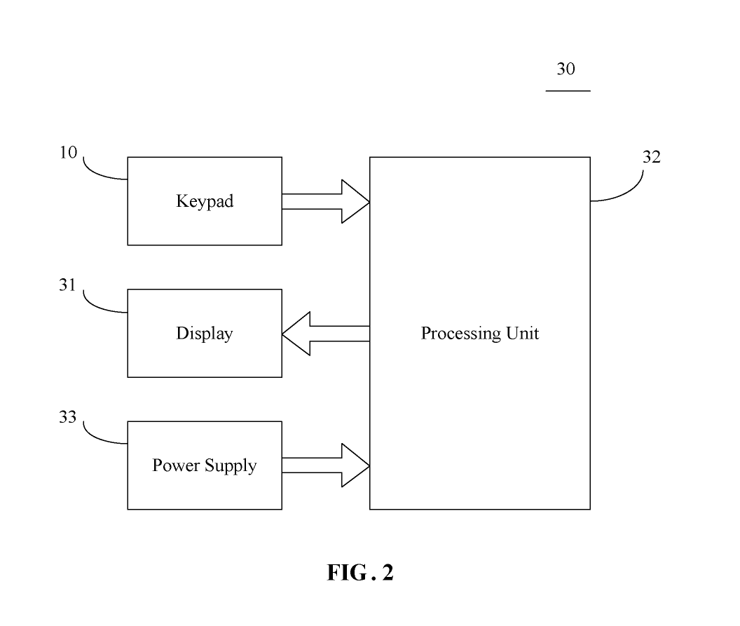

Referring to FIGS. 1 and 2, an electronic device 30 with a keypad 10 according to a first preferred embodiment of the present invention is disclosed. The electronic device 30 includes the keypad 10, a display 31, a processing unit 32, and a power supply 33. The keypad 10 is for inputting characters. The processing unit 32 receives an input from the keypad 10 and displays a corresponding character on the display 31.

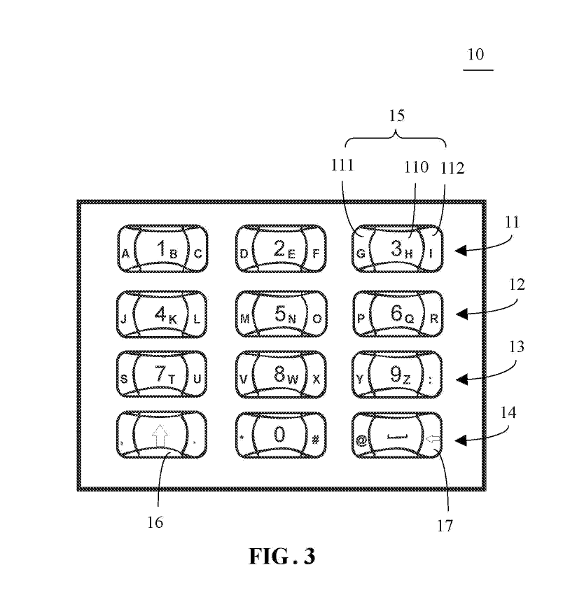

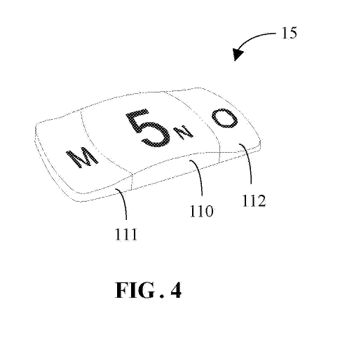

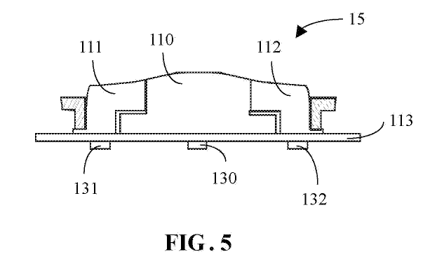

Referring to FIGS. 3, 4, and 5, the keypad 10 and combo keys 15 thereof are disclosed. The keypad 10 includes four key rows 11, 12, 13, 14. Each key row includes three combo keys 15. Each combo key 15 includes a main contact 110, and two sub-contacts 111, 112. The two sub-contacts 111, 112 are on opposite sides of the main contact 110.

Each main contact 110 of the key rows 11, 12, 13, 14 has a relatively large primary icon indicating a unique member of a first subset of a character set. The character set is the set of characters found on a typical keyboard. In the first preferred embodiment the first subset of a character set includes the number set, a predetermined symbol, and the space symbol, such as that shown in FIG. 2. Each main contact 110 of the key rows 11,12, 13 and each sub-contact 111 or 112 of the key rows 11, 12, 13, 14 also has a secondary icon indicating a unique member of a second subset of the character set. In the first preferred embodiment, the second subset includes the English alphabet and punctuation symbol, such as that shown in FIG. 2.

A main contact 16 and a sub-contact 17 of key row 14 are respectively designated as a function key for switching between a first input mode and a second input mode. In this embodiment, the first input mode is the number input mode, and the second input mode is the letter input mode. In the number input mode, the main contact 110 of the key rows 11, 12, 13, 14 are employed to input the primary icon (i.e., the number) indicated. In the second input mode, the main contact 110 of the key rows 11, 12, 13 are employed to input the secondary icon indicated.

Each combo key 15 of the keypad is further connected to a rubber pin 113. The rubber pin 113 includes touch points 130, 131, 132, corresponding to the main contact 110, the sub-contact 111, and the sub-contact 112 respectively. A depression of the main contact 110, the sub-contact 111, or the sub-contact 112 triggers the touch point 130, 131, 132 to electrically connect with an inner circuit (not shown) of the electronic device 30 correspondingly.

The main contact 110 and the sub-contacts 111, 112 can be depressed together or independently. When the main contact 110 is depressed, the processing unit 32 is programmed to accept the input from the main contact 110, and displays the character on the display 31 as depicted by the symbol on the main contact 110. When sub-contact 111 or when a combination of sub-contact 111 and the main contact 110 is/are depressed, the processing unit 32 is programmed to accept the input from the sub-contact 111 and displays the character on the display 31 as depicted by the symbol on the sub-contact 111. Similarly, when sub-contact 112 or when a combination of sub-contact 112 and the main contact 110 is/are depressed, the processing unit 32 is programmed to accept the input from the sub-contact 112 and displays the character on the display 31 as depicted by the symbol on the sub-contact 112.

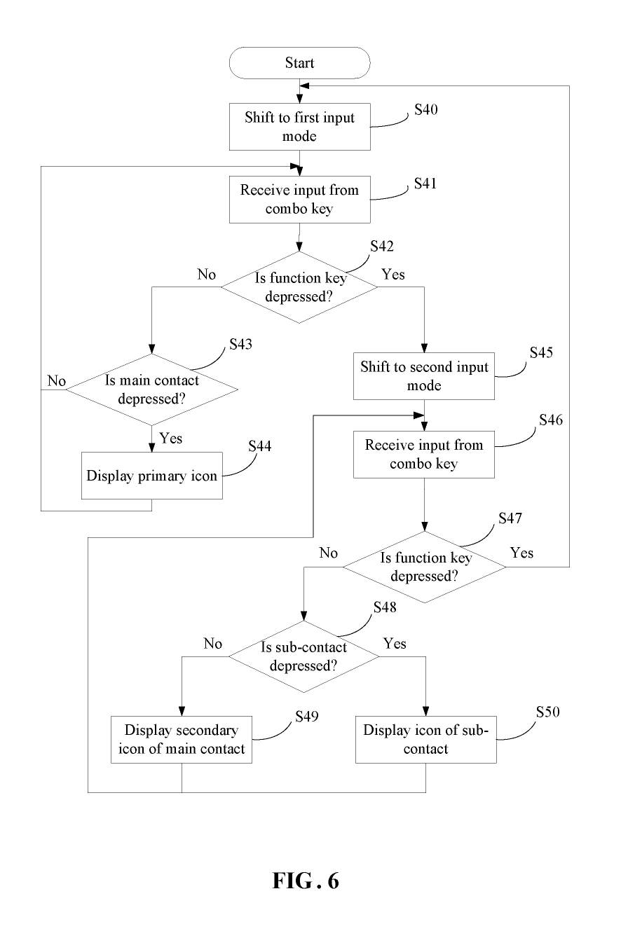

Referring to FIG. 6, a method of character inputs in the electronic device 30 is disclosed. When the character input procedure is started, in step S40, the electronic device 30 defaults to the first input mode then goes to step S41. In step S41, the electronic device 30 receives input signal from a combo key 15, then goes to step S42. In step S42, the electronic device 30 detects whether the function key 16, 17 is depressed. If the function key 16 or the function key 17 is depressed, goes to step S45; else, goes to step S43. In step S43, the electronic device 30 detects whether the main contact 110 of the combo key 15 is depressed. If the main contact 110 is depressed, goes to step S44, else, goes to step S41. In step S44, the electronic device 30 displays the primary icon (i.e., the number) indicated by the main contact 110 on the display 31, then goes to step S41. In step S45, the electronic device 30 shifts to the second input mode, then goes to step S46. In step S46, the electronic device 30 receives input signal from a combo key 15, then goes to step S47. In step S47, the electronic device 30 detects whether the function key 16, 17 is depressed. If the function key 16 or the function key 17 is depressed, goes to step S40; else, goes to step S48. In step S48, the electronic device 30 detects whether the sub-contact 111 or the sub-contact 12 is depressed. If the sub-contact 111 or the sub-contact 12 is depressed, goes to step S50; else goes to step S49. In step S49, the electronic device 30 displays the secondary icon (i.e., the alphabet letter) indicated by the main contact 110 on the display 31, then goes to step S46. In step S50, the electronic device 30 displays the secondary icon (i.e., the alphabet letter) indicated by the sub-contact 111 or the sub-contact 112 on the display 31, then goes to step S46.

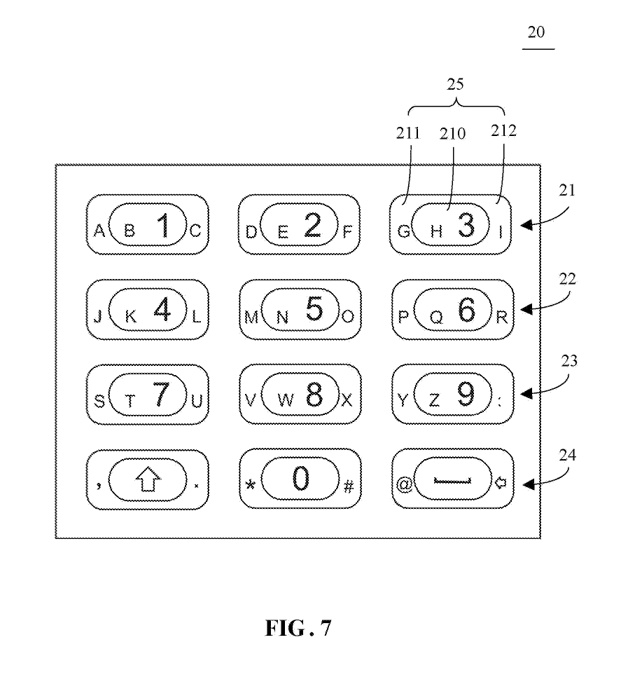

Referring to FIG. 7, another embodiment of a keypad used in the electronic device 30 is disclosed. The keypad 20 includes four key rows 21, 22, 23, 24. Each key row includes three combo keys 25. Each combo key 25 includes a main contact 210 and two sub-contacts 211, 212. The two sub-contacts 211, 212 are connected to each other and further enclose a main contact of the combo key. Other features of the keypad 20 are similar to keypad 10 mentioned above. Description to them is omitted here.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An apparatus for character inputs, the apparatus comprising:
a keypad comprising a plurality of combo keys, wherein each combo key comprises a main contact and at least one sub-contact adjacent to the main contact, the main contact and the sub-contact respectively have at least one icon representing a character; and
a processing unit for receiving a press operation on the keypad and inputting a corresponding character.

2. The apparatus of claim 1, wherein some of the main contacts have a first icon and a second icon, the first icon represents a number, and the second icon represents a letter.

3. The apparatus of claim 2, wherein the fist icon has a larger size than that of the second icon.

4. The apparatus of claim 2, wherein the main contact represents a letter in a letter mode.

5. The apparatus of claim 2, wherein the main contact represents a number in a number mode.

6. The apparatus of claim 1, further comprising a display for showing the character inputted.

7. The apparatus of claim 1, wherein each combo key comprises two sub-contacts.

8. The apparatus of claim 7, wherein the two sub-contacts are apart from each other.

9. The apparatus of claim 7, wherein the two sub-contacts are connected each other and further enclose the main contact of the combo key.

10. A method for character inputs in an electronic apparatus, comprising the steps of:
providing a keypad, wherein the keypad comprises a plurality of combo keys, each combo key includes a main contact and at least one sub-contact adjacent to the main contact, the main contact and the sub-contact respectively have at least one icon representing a character;
depressing a combo key;
inputting a corresponding character.

11. The method of claim 10, wherein some of the main contacts have a first icon and a second icon, the first icon represents a number, and the second icon represents a letter.

12. The method of claim 11, wherein the fist icon has a larger size than that of the second icon.

13. The method of claim 11, further comprising the step of:
providing a letter mode, wherein the main contact represents a letter.

14. The method of claim 11, further comprising the step of:
providing a number mode, wherein the main contact represents a number.

15. The method of claim 13, further comprising the steps of:
providing a function key;
if the function key is depressed, shift the input mode.

16. The method of claim 11, wherein each combo key comprises two sub-contacts.

17. The method of claim 16, wherein the two sub-contacts are apart from each other.

18. The method of claim 16, wherein the two sub-contacts are connected each other and further enclose the main contact of the combo key.

19. The method of claim 11, further comprising the steps of:
providing a display;
showing the character inputted on the display.
